(19) United States
(12) Patent Application Publication
(10) Pub. No.: US 2004/0094731 A1
(43) Pub. Date: May 20, 2004

(54) Radiation image read-out apparatus

(75) Inventor: Satoshi Arakawa, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/714,851

(22) Filed: Nov. 18, 2003

(30) Foreign Application Priority Data
Nov. 19, 2002 (JP) 335202/2002

(51) Int. Cl. G03B 42/08

(52) U.S. Cl. 250/585

(57) ABSTRACT

A radiation image read-out apparatus includes a radiation image convertor panel. A stimulating light projecting system projects stimulating light onto the radiation image convertor panel, and a sensor detects stimulated emission emitted from the radiation image convertor panel upon exposure to the stimulating light beam. The stimulating light projecting system projects, onto the radiation image convertor panel, stimulating light in a wavelength range where the rate of change of the intensity of the stimulated emission to a given change of the wavelength of the stimulating light is not larger than 1.0%/nm and is not smaller than −1.0%/nm.

### BACKGROUND OF THE INVENTION

1. Field of the Invention

This invention relates to a radiation image read-out apparatus, and more particularly to a radiation image read-out apparatus in which stimulated emission emitted from a radiation image convertor panel is detected to read a radiation image carried by the radiation image convertor panel.

2. Description of the Related Art

When certain kinds of phosphors are exposed to radiation such as X-rays, they store a part of energy of the radiation. Then when the phosphors which have been exposed to the radiation is exposed to stimulating light such as visible light, light is emitted from the phosphors in proportion to the stored energy of the radiation. Phosphors exhibiting such properties are generally referred to as “stimulable phosphors”. In this specification, the light emitted from the stimulable phosphors upon stimulation thereof will be referred to as “stimulated emission”. There has been known as a CR (computed radiography) a radiation image recording and reproducing system, comprising a radiation image recording apparatus and a radiation image read-out apparatus, in which a layer of the stimulable phosphors is exposed to a radiation passing through an object such as a human body to have a radiation image of the object stored on the stimulable phosphor layer as a latent image, stimulating light such as a laser beam having a constant intensity is projected onto the stimulable phosphor layer, and the stimulated emission emitted from the stimulable phosphor layer is photoelectrically detected, thereby obtaining an image signal (a radiation image signal) representing a radiation image of the object. There has been known a radiation image convertor panel comprising a stimulable phosphor layer formed on a substrate as a recording medium employed in the radiation image recording and reproducing system.

Various kinds of stimulable phosphors have been used and the properties of emitting the stimulated emission differ according to the kind of the stimulable phosphors employed. See, for instance, U.S. Pat. Nos. 4,258,264, 4,239,968 and 4,780,376.

There has been a demand for more accurately reading out a radiation image carried by the radiation image convertor panel. In attempts to meet the demand, there has been an attempt to suppress an unevenness in quality of the radiation image read out from the radiation image convertor panel caused by fluctuation in wavelength of the stimulating light. That is, even if the intensity of the stimulating light projected onto the radiation image convertor panel is kept constant, the intensity of the stimulated emission changes (the spectrum of the intensity of the stimulated emission changes) depending on the wavelength of the stimulating light. Accordingly, if the wavelength of the stimulating light fluctuates, for instance, due to a temperature change, the intensity of the stimulated emission emitted from the radiation image convertor panel changes, which results in an unevenness in quality of the radiation image readout. Since fluctuation in wavelength is especially large in a semiconductor laser, the above problem is especially serious in a system employing a semiconductor laser as a stimulating light source. Unevenness of image quality is enhanced when the radiation image is read out by the use of stimulating light in a wavelength range where the rate of change of the intensity of the stimulated emission to a given change of the wavelength of the stimulating light is increased.

When this applicant's radiation image read-out apparatuses are investigated from this viewpoint, the stimulating light projecting have projected, onto the radiation image convertor panel, stimulating light in a wavelength range where the rate of change of the intensity of the stimulated emission to a given change of the wavelength of the stimulating light is not larger than 2.0%/nm and is not smaller than −2.0%/nm. When the wavelength of the stimulating light is in such a range, it is difficult to accurately read out the radiation image recorded on the radiation image convertor panel.

### SUMMARY OF THE INVENTION

In view of the foregoing observations and description, the primary object of the present invention is to provide a radiation image read-out apparatus which can suppress unevenness in the image quality of an image read out from a radiation image convertor panel.

In accordance with the present invention, there is provided a radiation image read-out apparatus which comprises a radiation image convertor panel, a stimulating light projecting means which projects stimulating light onto the radiation image convertor panel, and a detecting means which detects stimulated emission emitted from the radiation image convertor panel upon exposure to the stimulating light beam and reads out a radiation image recorded on the radiation image convertor panel, wherein the improvement comprises that

the stimulating light projecting means projects, onto the radiation image convertor panel, stimulating light in a wavelength range where the rate of change of the intensity of the stimulated emission to a given change of the wavelength of the stimulating light is not larger than 1.0%/nm and is not smaller than −1.0%/nm.

Preferably, the rate of change of the intensity of the stimulated emission to a given change of the wavelength of the stimulating light is not larger than 0.5%/nm and is not smaller than −0.5%/nm.

For example, the stimulating light projecting means may comprise a plurality of stimulating light sources which emit stimulating light of different wavelengths and projects synthesized stimulating light including the stimulating light of different wavelengths onto the radiation image convertor panel so that the stimulating light of different wavelengths are simultaneously projected on the same position on the radiation image convertor panel.

Said rate of change δ∘ of the intensity of the stimulated emission to a given change of the wavelength of the stimulating light is a value obtained by dividing the inclination α∘ of a tangent at a particular wavelength λ∘ of a curve F representing the relation between the wavelength λ of the stimulating light and the intensity G of the stimulated emission emitted from the radiation image convertor panel exposed to a certain amount of stimulating light by the intensity G∘ of the stimulated emission at the particular wavelength λ∘ as shown in FIG. 3. That is, δ∘=α∘/G∘.

The radiation image convertor panel may have a stimulable phosphor layer formed of alkali halide stimulable phosphors.

The alkali halide stimulable phosphors include, for instance, those represented by formula MX:A, wherein M represents at least one of K, Rb and Cs, X represents at least one of Cl, Br and I, and A represents Eu²⁺ or T1⁺.

In accordance with the radiation image read-out apparatus of this invention, since the stimulating light projecting means projects, onto the radiation image convertor panel, stimulating light in a wavelength range where the rate of change of the intensity of the stimulated emission to a given change of the wavelength of the stimulating light is not larger than 1.0%/nm and is not smaller than −1.0%/nm, the change of the intensity of the stimulated emission emitted from the radiation image convertor panel can be minimized, whereby the unevenness of the image quality of the radiation image read out from the radiation image convertor panel can be suppressed, even if the wavelength of the stimulating light fluctuates during reading out a radiation image from the radiation image convertor panel.

When the stimulating light projecting means comprises a plurality of stimulating light sources which emit stimulating light of different wavelengths and simultaneously projects stimulating lights of different wavelengths on the same position on the radiation image convertor panel as synthesized stimulating light, the intensity of the stimulated emission representing the radiation image carried by the radiation image convertor panel can be a synthesized or averaged intensity of the stimulated emissions emitted from the radiation image convertor panel upon exposure to stimulating light of different wavelengths and accordingly, the change of the intensity of the stimulated emission emitted from the radiation image convertor panel can be further minimized, whereby the unevenness of the image quality of the radiation image read out from the radiation image convertor panel can be further suppressed.

Further, when a radiation image convertor has a stimulable phosphor layer formed of alkali halide stimulable phosphors, the present invention is especially useful since the alkali halide stimulable phosphors are especially large in the rate of change of the intensity of the stimulated emission to a given change of the wavelength of the stimulating light.

### BRIEF DESCRIPTION OF DRAWINGS

FIG. 1 is a perspective view briefly showing a radiation image read-out apparatus in accordance with an embodiment of the present invention,

FIG. 2 is an enlarged side view showing the stimulating beam projecting system and the detecting system employed in the radiation image read-out apparatus shown in FIG. 1,

FIG. 3 is a view showing the relation between the wavelength of the stimulating light and the intensity of the stimulated emission emitted from the radiation image convertor panel, and a wavelength range where the rate of change of the intensity of the stimulated emission to a given change of the wavelength of the stimulating light is not larger than 1.0%/nm and is not smaller than −1.0%/nm,

FIG. 4 is a view for illustrating the rate of change of the intensity of the stimulated emission to a given change of the wavelength of the stimulating light when the stimulating light is synthesized from light beams having different wavelengths, and

FIG. 5 is another view for illustrating the rate of change of the intensity of the stimulated emission to a given change of the wavelength of the stimulating light when the stimulating light is synthesized from light beams having different wavelengths.

### DESCRIPTION OF THE PREFERRED EMBODIMENTS

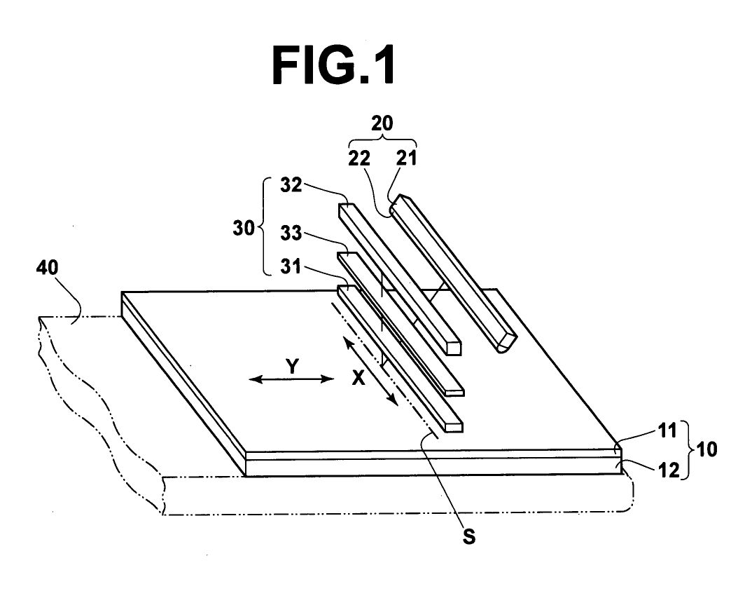

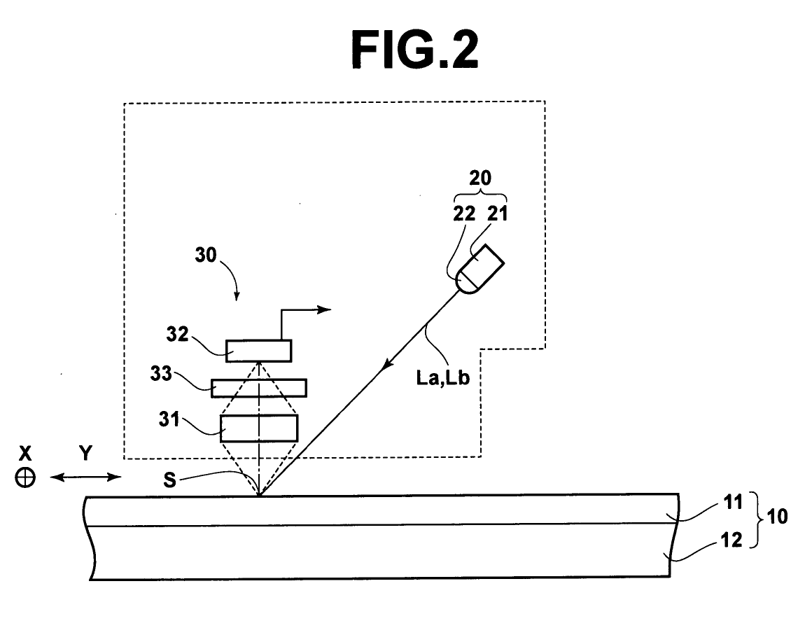

In FIGS. 1 and 2, a radiation image read-out apparatus 100 in accordance with an embodiment of the present invention comprises a stimulating light beam projecting system 20 which projects a stimulating light beam onto a radiation image convertor panel 10, a detecting system 30 which detects stimulated emission emitted from the radiation image convertor panel 10 upon exposure to the stimulating light beam.

The radiation image read-out apparatus 100 of this embodiment is for detecting by the detecting system 30 the stimulated emission emitted from the radiation image convertor panel 10 upon exposure to the stimulating light beam and reading out a radiation image carried by the radiation image convertor panel 10, and the stimulating light projecting system 20 projects, onto the radiation image convertor panel 10, stimulating light in a wavelength range where the rate of change of the intensity of the stimulated emission to a given change of the wavelength of the stimulating light is not larger than 1.0%/nm and is not smaller than −1.0%/nm.

The radiation image convertor panel 10 comprises a substrate 12 and astimulable phosphor layer 11 formed of alkali halide stimulable phosphors, which may be, for instance, Eu²⁺ activated stimulable phosphors containing therein alkali halide stimulable phosphors as a main component. For example, the stimulable phosphor layer 11 may be of stimulable phosphors containing therein, as a main component, alkali halide stimulable phosphors representing by formula CsX:Eu²⁺, wherein X represents Cl, Br or I.

The stimulating light projecting system 20 comprises a stimulating light source 21 comprising a plurality of semiconductor lasers which emit stimulating light La and Lb of different wavelengths and are arranged in a main scanning direction X, and a condenser optical system 22 which includes, for instance, a cylindrical lens extending in the main scanning direction X on the radiation image convertor panel 10 and converges the stimulating light beams La and Lb of different wavelengths in a line-like area S, and simultaneously projects onto the same position in the line-like area S of the radiation image convertor panel 10 stimulating light beams La and Lb. The stimulating light source 21 comprises a plurality of semiconductor lasers which emit stimulating light La and a plurality of semiconductor lasers which emit stimulating light Lb.

The detecting system 30 is provided with an imaging lens system 31 comprising a number of lens elements arranged in the main scanning direction X, e.g., a refractive index profile type lens, a stimulating light cut filter 33 which transmits the stimulated emission and cuts the stimulating light, and a line sensor 32 comprising a number of photodetector elements such as CCDs arranged in the main scanning direction X. The elements of the detecting system 30 are arranged in this order toward the radiation image convertor panel 10.

Operation of the radiation image read-out apparatus of this embodiment will be described, hereinbelow.

Stimulating light beams La and Lb emitted from the stimulating light projecting system 20 are converged in a line-like area S on the radiation image convertor panel 10. The stimulated emission emitted from the line-like area S of the radiation image convertor panel 10 upon exposure to the stimulating light beams La and Lb are imaged on the line sensor 32 through the imaging lens system 31 and the stimulating light cut filter 33 and are photoelectrically converted to be output as electric image signal components. While projecting the stimulating light beams La and Lb and detecting the stimulated emission, the radiation image convertor panel 10 is conveyed by a conveyor means 40 in a sub-scanning direction Y, whereby an image recorded on the radiation image convertor panel 10 is read out.

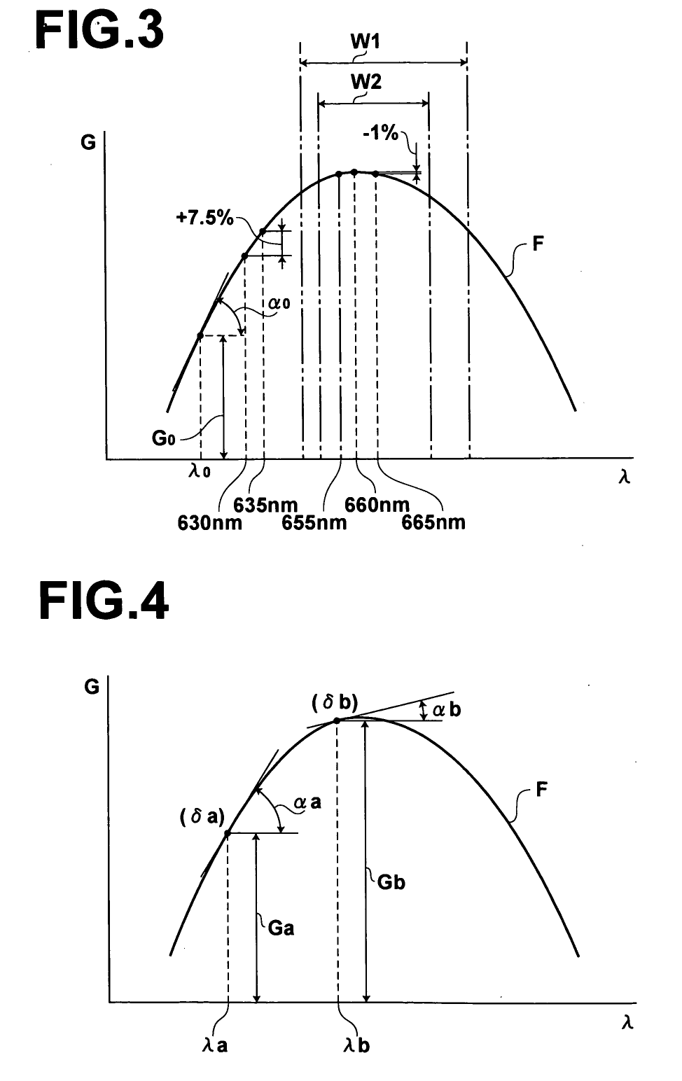

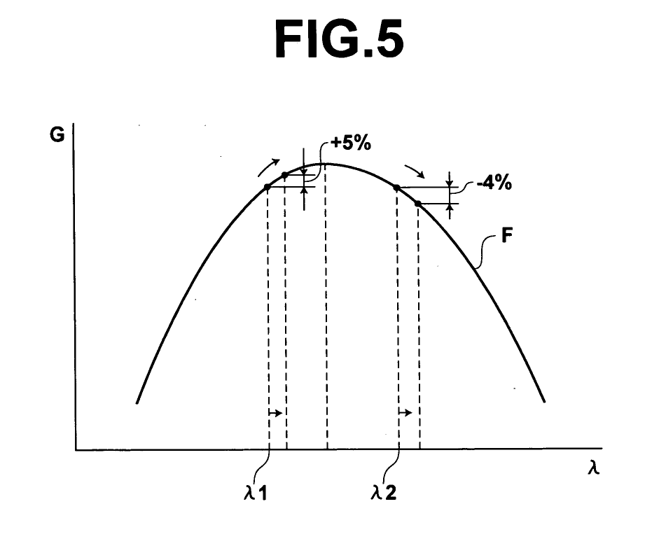

The relation between fluctuation in the stimulating light emitted from the stimulating light projecting system 20 and the intensity of the stimulated emission emitted from the radiation image convertor panel 10 upon exposure to the stimulating light will be described, hereinbelow. FIG. 3 is a view showing the relation between the wavelength of the stimulating light and the intensity of the stimulated emission emitted from the radiation image convertor panel, and a wavelength range where the rate of change of the intensity of the stimulated emission to a given change of the wavelength of the stimulating light is not larger than 1.0%/nm and is not smaller than −1.0%/nm, and FIGS. 4 and 5 are views respectively for illustrating the rates of change of the intensity of the stimulated emission to a given change of the wavelength of the stimulating light when the stimulating light is of other wavelengths.

The intensity of stimulated emission emitted from a radiation image convertor panel 10 upon exposure to stimulating light of a given intensity changes according to the wavelength of the stimulating light, and the relation between the wavelength λ of the stimulating light and the intensity G of the stimulated emission is as shown by curve F in FIG. 3 where, when the wavelength λ of the stimulating light is 655 nm, the intensity G of the stimulated emission is maximized (peak intensity) and as the deviation of the wavelength λ of the stimulating light from 655 nm becomes larger, the intensity G of the stimulated emission becomes lower and at the same time, the rate of change of the intensity of the stimulated emission to a given change of the wavelength of the stimulating light becomes larger. The inclination of the tangent of the curve F becomes larger as the deviation of the wavelength λ of the stimulating light from 655 nm becomes larger.

When the radiation image convertor panel 10 has such properties, fluctuation in the wavelength of the stimulating light during reading out a radiation image from the radiation image convertor panel 10 results in fluctuation of the stimulated emission. For example, when the wavelength of the stimulating light shifts by 5 nm from 630 nm to 635 nm, the intensity of the stimulated emission increases by about 7.5%. That is, the intensity of the stimulated emission emitted from the radiation image convertor panel 10 upon exposure to stimulating light of a wavelength of 635 nm is higher by about 7.5% than that emitted from the radiation image convertor panel 10 upon exposure to stimulating light of a wavelength of 630 nm.

Whereas, when the wavelength of the stimulating light shifts by 5 nm from 660 nm to 665 nm, the intensity of the stimulated emission changes by about −1.0%. That is, when a radiation image is read out from the radiation image convertor panel 10, the rate of change of the intensity of the stimulated emission to a given change of the wavelength of the stimulating light can be suppressed by using stimulating light whose wavelength is near to the peak of the curve F.

The wavelength range W1 where the rate of change of the intensity of the stimulated emission to a given change of the wavelength of the stimulating light is not larger than 1.0%/nm and is not smaller than −1.0%/nm is a range from about 645 nm to 705 nm, and even if the wavelength of the stimulating light is fluctuated by 5 nm in this range, the change of the intensity of the stimulated emission is not larger than 5%.

The wavelength range W2 where the rate of change of the intensity of the stimulated emission to a given change of the wavelength of the stimulating light is not larger than 0.5%/nm and is not smaller than −0.5%/nm is a range from about 650 nm to 695 nm, and even if the wavelength of the stimulating light is fluctuated by 5 nm in this range, the change of the intensity of the stimulated emission is not larger than 2.5%.

The rate of change δ∘ of the intensity of the stimulated emission to a given change of the wavelength of the stimulating light is a value obtained by dividing the inclination α∘ of a tangent at a particular wavelength λ∘ of a curve F representing the relation between the wavelength λ of the stimulating light and the intensity G of the stimulated emission emitted from the radiation image convertor panel exposed to a certain amount of stimulating light by the intensity G∘ of the stimulated emission at the particular wavelength λ∘ as shown in FIG. 3. That is, δ∘=α∘/G∘. The following table numerically shows the relation between the wavelength of the stimulating light and the rate of change δ∘ of the intensity of the stimulated emission to a given change of the wavelength of the stimulating light.

TABLE

| λ (nm) | δ o (%) |
|---|---|
| 600 | 2.96 |
| 610 | 2.31 |
| 620 | 1.87 |
| 630 | 1.66 |
| 640 | 1.31 |
| 650 | 0.52 |
| 660 | −0.14 |
| 670 | −0.27 |
| 680 | −0.30 |
| 690 | −0.35 |
| 700 | −0.72 |
| 710 | −1.11 |
| 720 | −2.04 |
| 730 | −2.89 |

A case where stimulating light beams La and Lb of different wavelengths are simultaneously projected onto the same position on the radiation image convertor panel 10 will be described in detail, hereinbelow.

When the stimulating light projecting means 20 comprises a plurality of semiconductor lasers which emit stimulating light La and Lb of different wavelengths and simultaneously projects stimulating lights La and Lb of different wavelengths on the same position on the radiation image convertor panel 10 as synthesized stimulating light, the intensity of the stimulated emission representing the radiation image carried by the radiation image convertor panel 10 can be a synthesized intensity of the stimulated emissions emitted from the radiation image convertor panel 10 upon exposure to stimulating lights of different wavelengths. That is, even if the rate of change δa of the intensity of the stimulated emission to a given change of the wavelength of the stimulating light is large in one of the stimulating lights (stimulating light of a wavelength of λa in FIG. 4, δa=αa/Ga), the rate of change δb of the intensity of the stimulated emission to a given change of the wavelength of the stimulating light is small in the other stimulating lights (stimulating light of a wavelength of λb in FIG. 4) and accordingly, the change of the intensity of the stimulated emission emitted from the radiation image convertor panel 10 can be the sum of intensity Ga of the stimulated emission emitted from the radiation image convertor panel 10 upon exposure to the stimulating light of a wavelength of λa and that Gb emitted from the radiation image convertor panel 10 upon exposure to the stimulating light of a wavelength of λb, whereby the rate of change δa and the rate of change δb are averaged. Accordingly, a sharp change of the overall intensity (Ga+Gb) of the stimulated emission with change of the wavelength of the stimulating light can be avoided.

Further, when wavelengths λ1 and λ2 of stimulating lights La and Lb are on opposite sides of the peak of the curve F as shown in FIG. 5, and are, for instance, 640 nm and 700 nm, respectively, and the wavelengths λ1 and λ2 are increased by 5 nm due to, for instance, a temperature change, increase in intensity of the stimulated emission due to the shift of the wavelength of the stimulating light La is cancelled by reduction in intensity of the stimulated emission due to the shift of the wavelength of the stimulating light Lb, whereby fluctuation in the intensity of the stimulated emission due to fluctuation in the wavelength of the stimulating light can be further suppressed. That is, the change in the intensity of the stimulated emission is about +5% when the wavelength of the stimulating light La is shifted from 640 nm to 645 nm, whereas the change in the intensity of the stimulated emission is about −4% when the wavelength of the stimulating light Lb is shifted from 700 nm to 705 nm, and accordingly, the former and the latter cancels each other, whereby the overall change in the intensity of the stimulated emission can be suppressed to about +1%.

When stimulating light in a wavelength range where the rate of change of the intensity of the stimulated emission to a given change of the wavelength of the stimulating light is outside the range not larger than 2.0%/nm and is not smaller than −2.0%/nm is projected onto the radiation image convertor panel 10, the change of the intensity of the stimulated emission due to shift of the wavelength of the stimulating light by 5 nm becomes larger than 10% in an absolute value, and non-negligible change in density is generated in the radiation image read out. The laser beam emitted from a semiconductor laser can fluctuate by 5 nm in wavelength under the normal working conditions. Further, when stimulating light in a wavelength range where the rate of change of the intensity of the stimulated emission to a given change of the wavelength of the stimulating light is outside the range not larger than 1.0%/nm and is not smaller than −1.0%/nm is projected onto the radiation image convertor panel 10, the change of the intensity of the stimulated emission due to shift of the wavelength of the stimulating light by 0.2 nm becomes larger than 0.2% in an absolute value, and unevenness in the image quality can be visually recognized in the radiation image read out.

Generally, the wavelengths of laser beams emitted from a pair of semiconductor lasers cannot be accurately coincide with each other even if they are of the same structure, and change of the wavelength of a laser beam emitted from a semiconductor laser due to a temperature change differs laser to laser even if they are of the same structure. Accordingly, the stimulating light projecting system which projects as the stimulating light a laser beam synthesized from a plurality of laser beams emitted from a plurality of semiconductor lasers of the same structure substantially includes a plurality of light sources emitting lights of different wavelengths. In such a case, by employing semiconductor lasers emitting laser beams in the wavelength range described above, unevenness in the image quality can be greatly suppressed.

The stimulating light projecting system 20 may comprise a plurality of stimulating light sources emitting stimulating lights of the same wavelength or a single stimulating light source so long as it can project, onto the radiation image convertor panel 10, stimulating light in a wavelength range where the rate of change of the intensity of the stimulated emission to a given change of the wavelength of the stimulating light is not larger than 1.0%/nm and is not smaller than −1.0%/nm.

It is not essential that the radiation image convertor panel 10 has a stimulable phosphor layer formed of alkali halide stimulable phosphors but the radiation image convertor panel 10 may have a stimulable phosphor layer formed of other types of stimulable phosphors.

What is claimed is;

1. A radiation image read-out apparatus which comprises a radiation image convertor panel, a stimulating light projecting means which projects stimulating light onto the radiation image convertor panel, and a detecting means which detects stimulated emission emitted from the radiation image convertor panel upon exposure to the stimulating light beam and reads out a radiation image recorded on the radiation image convertor panel, wherein the improvement comprises that
the stimulating light projecting means projects, onto the radiation image convertor panel, stimulating light in a wavelength range where the rate of change of the intensity of the stimulated emission to a given change of the wavelength of the stimulating light is not larger than 1.0%/nm and is not smaller than −1.0%/nm.

2. A radiation image read-out apparatus as defined in claim 1 in which the rate of change of the intensity of the stimulated emission to a given change of the wavelength of the stimulating light is not larger than 0.5%/nm and is not smaller than −0.5%/nm.

3. A radiation image read-out apparatus as defined in claim 1 in which the stimulating light projecting means comprises a plurality of stimulating light sources which emit stimulating light of different wavelengths and projects synthesized stimulating light including the stimulating light of different wavelengths onto the radiation image convertor panel so that the stimulating light of different wavelengths are simultaneously projected on the same position on the radiation image convertor panel.

4. A radiation image read-out apparatus as defined in claim 1 in which the radiation image convertor panel has a stimulable phosphor layer formed of alkali halide stimulable phosphors.

5. A radiation image read-out apparatus as defined in claim 4 in which the alkali halide stimulable phosphors are represented by formula MX:A, wherein M represents at least one of K, Rb and Cs, X represents at least one of Cl, Br and I, and A represents Eu²⁺ or T1⁺.
